(19) United States
(12) Patent Application Publication
(10) Pub. No.: US 2006/0156876 A1
(43) Pub. Date: Jul. 20, 2006

(54) Motion control system and method for a high speed inserter input

(75) Inventors: John W. Sussmeier, Cold Spring, NY (US); Arthur H. DePoi, Brookfield, CT (US); Gregory P. Skinger, Southbury, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/039,425

(22) Filed: Jan. 19, 2005

(51) Int. Cl. B26D 1/00; B26D 7/06

(52) U.S. Cl. 83/13; 83/29; 83/155; 83/371; 414/789.9

(57) ABSTRACT

A high speed input system for an inserter machine. The system controlling a guillotine cutter, a cutter transport, and an upstream web handler transport to increase throughput for mail production. The controller is programmed to control the high speed input module in accordance with a repeating cycle. The cycle time is determined as an amount of time between a first web feed request and an earliest possible time that a subsequent second web feed request can be acted upon. A cutter transport motion control profile initiates feeding of a document length of web after receiving the first feed request. The cutter motion control profile causes the cutter blade to begin descending when the cutter transport has moved the web a trigger distance, calculated such that the cutter blade will first make contact with the web immediately when the web has been halted by the cutter transport motion profile. A web handler transport profile moves the web the document length at velocities and accelerations less than the velocities and accelerations of the cutter transport. At the end of the cycle, the web handler transport causes the web to be transported at a nominal velocity selected to maintain an appropriate amount of the web loop in the web handler. Within the web handler a control loop expands and contracts as the downstream cutter transport stops and starts as the cutter blade cuts the web in each cycle.

### FIELD OF THE INVENTION

The present invention relates generally to the input portion of a high speed inserter system in which individual sheets are cut from a continuous web of printed paper for use in mass-production of mail pieces.

### BACKGROUND OF THE INVENTION

Inserter systems, such as those applicable for use with the present invention, are typically used by organizations such as banks, insurance companies and utility companies for producing a large volume of specific mailings where the contents of each mail item are directed to a particular addressee. Also, other organizations, such as direct mailers, use inserts for producing a large volume of generic mailings where the contents of each mail item are substantially identical for each addressee. Examples of such inserter systems are the 8 series, 9 series, and APS™ inserter systems available from Pitney Bowes Inc. of Stamford, Conn.

In many respects, the typical inserter system resembles a manufacturing assembly line. Sheets and other raw materials (other sheets, enclosures, and envelopes) enter the inserter system as inputs. Then, a plurality of different modules or workstations in the inserter system work cooperatively to process the sheets until a finished mail piece is produced. The exact configuration of each inserter system depends upon the needs of each particular customer or installation.

Typically, inserter systems prepare mail pieces by gathering collations of documents on a conveyor. The collations are then transported on the conveyor to an insertion station where they are automatically stuffed into envelopes. After being stuffed with the collations, the envelopes are removed from the insertion station for further processing. Such further processing may include automated closing and sealing the envelope flap, weighing the envelope, applying postage to the envelope, and finally sorting and stacking the envelopes.

The input stages of a typical inserter system are depicted in FIG. 1. At the input end of the inserter system, rolls or stacks of continuous printed documents, called a “web,” are fed into the inserter system by a web feeder 10. The continuous web must be separated into individual document pages. This separation is typically carried out by a web cutter 20 that cuts the continuous web into individual document pages. In a typical web cutter 20, a continuous web of material with sprocket holes on both side of the web is fed from a fanfold stack from web feeder 10 into the web cutter 20. The web cutter 20 has a tractor with pins or a pair of moving belts with sprockets to move the web toward a guillotinecutting module 20 for cutting the web cross-wise into separate sheets. Perforations are provided on each side of the web so that the sprocket hole sections of the web can be removed from the sheets prior to moving the cut sheets to other components of the mailing inserting system. Downstream of the web cutter 20, a right angle turn 30 may be used to reorient the documents, and/or to meet the inserter user's floor space requirements.

The separated documents must subsequently be grouped into collations corresponding to the multi-page documents to be included in individual mail pieces. This gathering of related document pages occurs in the accumulator module 40 where individual pages are stacked on top of one another. The control system for the inserter senses markings on the individual pages to determine what pages are to be collated together in the accumulator module 40.

Downstream of the accumulator 40, a folder 50 typically folds the accumulation of documents, so that they will fit in the desired envelopes. To allow the same inserter system to be used with different sized mailings, the folder 50 can typically be adjusted to make different sized folds on different sized paper. As a result, an inserter system must be capable of handling different lengths of accumulated and folded documents. Downstream of the folder 50, a buffer transport 60 transports and stores accumulated and folded documents in series in preparation for transferring the documents to the synchronous inserter chassis 70.

In a typical embodiment of a web cutter 20, the guillotine cutter arrangement requires that the web be stopped during the cutting process. As a result, the web cutter 20 transports the web in a sharp starting and stopping fashion and subjects the web to high accelerations and decelerations.

With the guillotine cutter arrangement, the web feeder 10 may typically include a loop control module to provide a loop of slack web to be fed into the web cutter 20. During high speed operation, the accelerations experienced by the web in the slack loop can be quite severe. The inertia experienced by the web from the sudden starting and stopping may cause it to tear or become damaged.

FIG. 2 shows more details of an input portion of an inserter system. For purposes of the present invention it is not important whether a particular functionality be included one module or another, and the description of one module having a certain functionality is exemplary. A web 120 is drawn into the inserter input subsystem. Methods for transporting the web are known and may include rollers, or tractors pulling on holes along a perforated strip at the edges of the web. The web 120 is split into two side-by-side portions by a cutting device 11. Cutting device 11 may be a stationary knife or a rotating cutting disc, or any other cutting device known in the art. While the embodiment in FIG. 2 shows the web being split into two portions, one skilled in the art will understand that a plurality of cutting devices 11 may be used to create more than two strands of web from the original one.

Sensors 12 and 13 scan a mark or code printed on the web. The mark or code identify which mail piece that particular portion of web belongs to, and provides instructions for processing and assembling the mail pieces. In addition to using the scanned information for providing assembling instructions, the scanning process is useful for tracking the documents' progress through the mail piece assembly process. Once the location of a document is known based on a sensor reading, the document's position may be tracked throughout the system by monitoring the displacement of the transport system. In particular, encoders may be incorporated in the transport systems to give a reliable measurement of displacements that have occurred since a document was at a certain location.

After the web 120 has been split into at least two portions, the web is then cut into individual sheets by cutter 21. The cut is made across the web, transverse to the direction of transport. Downstream of the cutter 21 the individual cut sheets are transported by nips 23. Nips 24 further serve to transport the sheets to the right angle turn 30 portion of the system.

Right angle turn devices 30 are known in the art and will not be described in detail here. However, and exemplary right angle turn will comprise turn bars 32 and 33. Of the two paper paths formed by the right angle turn 30, turn bar 33 forms an inner paper path for transporting sheet 1. Turn bar 32 forms a longer outer paper path on which sheet 2 travels.

Because sheets 1 have a shorter path through the right angle turn 30, a lead edge of sheet 1 will be in front of a lead edge of sheet 2 downstream of the right angle turn 30. Also, the turn bars 32 and 33 are arranged such that sheet 2 will lay on top of sheet 1 downstream of the right angle turn, thus forming a shingled arrangement. Downstream of the right angle turn 30, further sets of roller nips 36 transport the shingled arrangement of sheets.

In a feed cycle, the paper is advanced past the blade of the guillotine cutter 21 by a distance equal to the length of the cut sheet and is stopped. In a cut cycle, the blade 21 lowers to shear off the sheet of paper, and then withdraws from the paper. As soon as the blade 21 withdraws from the paper path, the next feed cycle begins. The feed and cut cycles are carried out in such an alternate fashion over the entire operation.

In some web cutters, it is desirable to achieve a cutting rate of 25,000 cuts per hour or more, for example. This means that the web cutter has a feed/cut cycle of 144 ms. Typically the length of the cut sheet is 11 inches (27.94 cm). If the time to complete a cut cycle is about 34 ms, then the total time in a feed cycle is 110 ms. This means that the web must be accelerated from a stop position to a predetermined velocity and then decelerated in order to stop again within 110 ms. As guillotine cutters are required to generate pages even faster (up to 36,000 cuts per hour), precise motion control coordinated over various mechanisms must be implemented in order to eliminate web breakage and to reliably cut sheets of proper length at high rates to provide to downstream devices.

### SUMMARY OF THE INVENTION

The present invention provides a high speed input system for an inserter machine that is capable of faster, more accurate, and more reliable high speed cutting. In particular, the manner of controlling the guillotine cutter, the cutter transport, and an upstream web handler transport provide a novel way to increase throughput for mail production. The system in accordance with the present invention is used for separating individual sheets from a continuous web for creating mail pieces in an inserter machine. A first component of the system is a guillotine cutter blade arranged to cyclically lower and raise to transversely cut the web transported below the cutter blade. A cutter transport is arranged to cyclically feed and stop the web in a path below the cutter blade for cutting by the cutter blade. A web handler transport is positioned upstream of the cutter transports and provides web to the cutter transport at lower peak velocities and accelerations than are experienced by the web at the cutter transport. The web handler transport includes a loop forming arrangement to act as a buffer between the drastic motion changes of the cutter transport and the steadier movement of the web handler transport.

The system is controlled to maximize throughput with a controller. The controller is programmed to control the high speed input module in accordance with a repeating cycle. The cycles have cycle times that can vary in length. The cycle time is determined as an amount of time between a first web feed request and an earliest possible time that a subsequent second web feed request can be acted upon. At the beginning of each cycle, the controller controls the system in accordance with predetermined motion control profiles for the various components.

In particular, a cutter transport motion control profile initiates feeding of a document length of web after receiving the first feed request. Under this profile, the cutter transport stops after the document length of web has been fed.

A cutter motion control profile causes the cutter blade to begin descending when the cutter transport has moved the web a trigger distance, less than the document length, and while the web is still moving. The trigger distance is calculated such that the cutter blade will first make contact with the web as soon as it has been halted by the cutter transport motion profile. The cutter blade is raised back to its initial position after having completed its cutting of the web. Also, the cutter transport motion control profile begins moving the web in response to a second feed request, for a subsequent cycle, as soon as the cutter blade rises above a horizontal level of the web, and not waiting until the cutter blade is at a resting position above the web.

A web handler transport motion control profile is also initiated during each cycle. The web handler transport profile moves the web the document length at velocities and accelerations less than the velocities and accelerations of the cutter transport. At the end of the cycle, the web handler transport causes the web to be transported at a nominal velocity selected to maintain an appropriate amount of the web loop in the web handler. The loop expands and contracts as the downstream cutter transport stops and starts as the cutter blade cuts the web in each cycle.

In a preferred embodiment, the cutter transport motion control profile is comprised of a constant acceleration for half of the document length and a constant deceleration for the other half of the document length. Similarly, it is preferred that the web handler transport motion control profile comprises steady motion at the nominal velocity in steady state operation. In a non-steady state embodiment, if no feed request is present at the end of the cycle, the web handler transport motion control profile decelerates the web at a constant deceleration until the web comes to a stop, or until a subsequent feed request is received.

Preferably, the web handler transport motion control profile also includes an intercept algorithm that is employed at the beginning of each cycle. The intercept algorithm calculates the appropriate web handler transport motion control profile to accomplish a displacement of the document length within the cycle time starting at a current velocity and ending at the nominal velocity. In a further preferred embodiment, the intercept algorithm calculates the web handler transport motion control profile as a constant acceleration and a constant deceleration during the cycle.

Also in the preferred embodiment, the cutter blade is coupled by a cutter arm to a rotary motor. One full rotation of the rotary motor corresponds to one complete down and up movement of the cutter blade. The cutter blade motion control profile may be comprised of a constant rotary acceleration for a first half of the rotation while the cutter blade is descending and a constant deceleration for a second half of the rotation while the cutter blade is ascending.

In a further embodiment, the controller includes a start-up profile for handling the web as it is first installed into the high speed input module. The start-up profile controls the cutter transport and the web handler transport to bring a lead edge of the web to a first cut location. The web handler is further controlled to execute a nominal loop displacement. The nominal loop displacement is a function of a differential displacement between the cutter transport and the web handler transport during a portion of the cycle while the cutter transport operates at a higher velocity than the web handler transport. Thus, the appropriate quantity of loop is provided for the system to begin steady-state operation.

In the preferred embodiment, the system operates on a web having a 2-up sheet configuration having sheets side-by-side on the web. To separate the side-by-side sheets, the system includes a center cutting device positioned upstream of the guillotine cutter. The center cutting device splits the side-by-side portions of the web prior to cutting by the guillotine blade.

Further details of the present invention are provided in the accompanying drawings, detailed description, and claims.

### BRIEF DESCRIPTION OF THE DRAWINGS

FIG. 1 depicts the initial stages of an inserter system for use with the present invention.

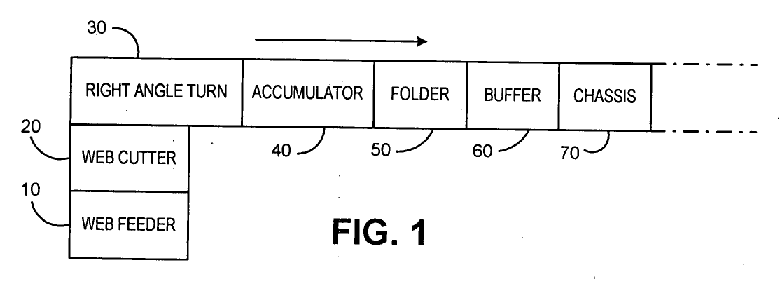

FIG. 2 is a preferred embodiment of an input portion of an inserter system for use with the present invention.

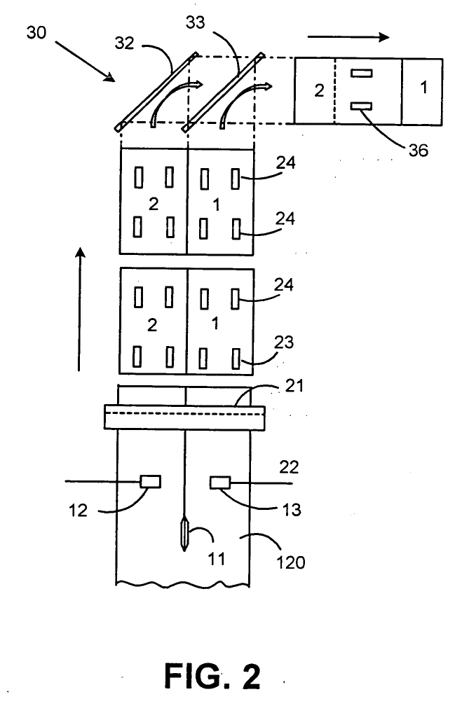

FIGS. 3a and 3b depict a preferred arrangement of the cutter transport and the web handling transport.

FIGS. 4a, 4b, and 4c depict a view of a guillotine cutter blade cutting across a sheet of web in varying stages.

FIG. 5 is a diagrammatic representation of a preferred embodiment of rotary driven cutter blade.

FIG. 6 depicts a graph of preferred motion control profiles for steady state operation of an inserter input module.

FIG. 7 is a graph of an intercept profile used by the web handler transport during an exemplary operation cycle.

### DETAILED DESCRIPTION

A previously filed patent application titled METHOD AND DEVICE FOR REDUCING WEB BREAKAGE IN A WEB CUTTER, U.S. patent application Ser. No. 10/431,237 (Attorney Docket F-616) includes descriptions of components related to the present invention, and that application is hereby expressly incorporated by reference in its entirety.

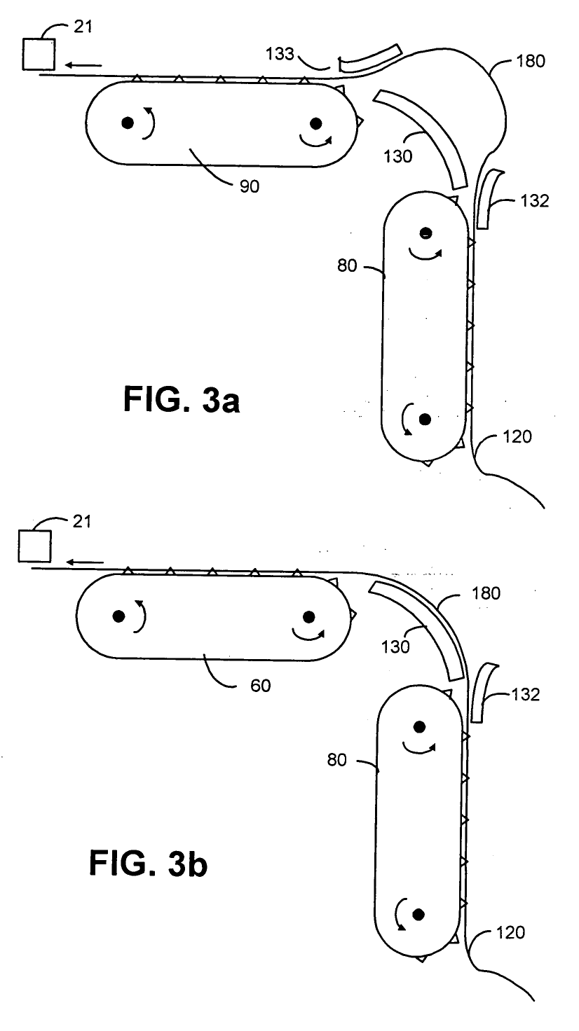

A preferred embodiment for arrangement of the components of the high speed web input system is illustrated in FIGS. 3a and 3b. As shown in FIGS. 3a and 3b, the input system arrangement comprises a cutter transport 90 and a web handler transport 80 for moving the web 120 from an upstream source to a cutter 21. The preferred arrangement can effectively reduce the inertial forces acting on the web paper immediately upstream from the cutter transport 90. The reduction in inertia is achieved by disposing the web handler transport 80 upstream from the cutter transport 90, forming a partial paper loop 180 between the cutter transport 90 and the web handler transport 80. Furthermore, the second tractor 80 is oriented such that the inertia acting on the loop 180 can be effectively reduced.

In particular, when the cutter transport 90 moves the web in a direction substantially in a horizontal plane, the web handler transport 80 is oriented such that it moves the web in a direction substantially in a vertical plane. As such, the web is pushed upward when it enters the loop 180. As shown in FIGS. 3a and 3b a support deck 130 is used to support the loop 180 and a paper guide 132 is used to guide the web when the loop 180 is formed. A further paper guide 133 may be used to guide the paper path on the on the opposite side of the loop 180 from guide 132.

It is preferred that the control loop 180 be small so as to reduce the inertia acting on the web. In order to achieve a small control loop 180, both the cutter transport 90 and the web handler transport 80 are set in motion in a coordinated way. In particular, both the cutter transport 90 and the web handler transport 80 are designed to accelerate and decelerated in a related operation cycle. Because only the cutter transport 90 must stop to allow for the cutting cycle, the web handler transport 80 can accelerate and decelerate differently from the cutter transport 90. Thus, while the cutter transport 90 operates at full acceleration and advances the web 120 as quickly as possible, the web handler transport 80 operates at a lower acceleration rate. This lower acceleration rate reduces the breakage of the web as the web paper is pulled by the web handler transport 80 from the upstream source. At the same time, because the paper at the control loop 180 is moved by the web handler transport 80 toward the cutter transport 90, the stop-and-start motion of the cutter transport 90 does not produce as severe a pull on the paper.

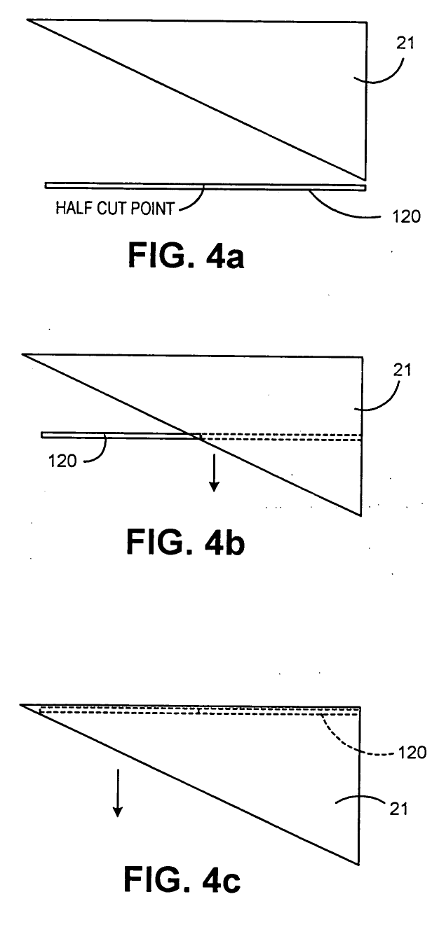

FIGS. 4a-4c depict the guillotine cutter 21 through a downward cutting motion, starting at a beginning position in 4a, to a finished cut position in 4c. Guillotine cutter blade 21 preferably has an edge that is vertically inclined at an angle above the path of web 120. As the blade 21 is lowered (FIG. 4b) the blade 21 edge comes into contact with the web 120 and cuts across its width (from right to left in FIGS. 4a-c). In FIG. 4c, the blade has reached its bottom position, and the whole width of the web 120 has been cut. In an alternative scenario, blade 21 can be stopped at the position shown in FIG. 4b, and only the right half of the web 120 has been cut. This technique is used when the web 120 is comprised of side-by-side sets of sheets, and where only one of the sheets belongs to the mailpiece that is currently being processed. The other half of the web 120 can be cut when the system is ready to start processing the collection of sheets for the next mailpiece.

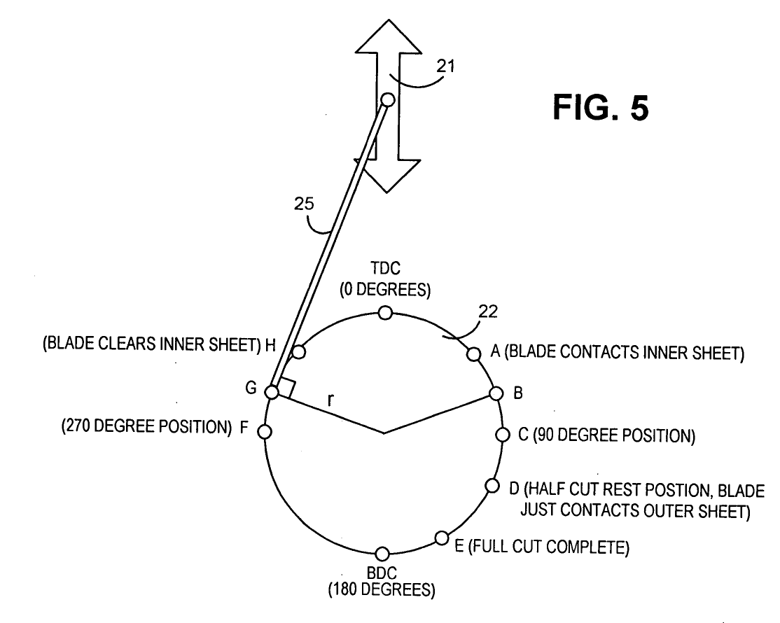

FIG. 5 is a diagram depicting a preferred embodiment for driving the motion of the cutter blade 21. Cutter blade 21 is linked to a rotary motor 22 by an arm (or crank) 25. As the motor 22 makes a 360 degree rotation in the clockwise direction, the cutter blade 21 undergoes a complete down and up cutting cycle. When the arm 25 is rotated to point TDC, the blade 21 is positioned at top-dead-center above the web 120. When the motor 22 has rotated the arm 25 to position BDC, the blade will be at bottom-dead-center of its cutting cycle.

It will be understood by those skilled in the art that motor 22 may also be coupled to the crank 25 through a coupling ratio other than unity. Thus a complete 360 degree cutting cycle may actually correspond to more or less than a full rotation of a motor, or even multiple rotations. Accordingly, the term “rotary motor” in this application shall be understood to mean the motor and any corresponding coupling that results in movement of the crank 25.

Positions A-H of the rotary motor 22 in FIG. 5 are other key positions in the cutting cycle. Position A represents the point on the rotation where the blade 21 first comes into contact with the web. Position A in FIG. 5 would roughly correspond to the position of the blade 21 depicted in FIG. 4a. Position D in FIG. 5 represents a half-cut position that corresponds to the blade 21 position in FIG. 4b. Rotary position E represents the position in the rotary cycle of motor 22 where the web 120 has been completely cut (FIG. 4c). The blade 21 completes its downward movement at BDC in the rotary cycle, and rises back up from BDC to TDC. At position H, while rising, the blade 21 rises above the horizontal position of the web 120. In the preferred embodiment, as will be described further below, the cutter transport 90 resumes transport of the web after point H in the rotary cutting cycle has passed.

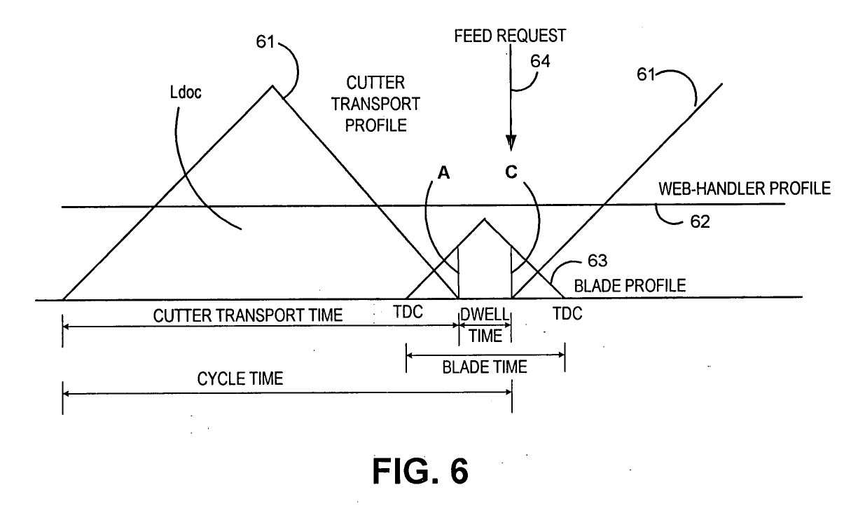

FIG. 6 depicts the motion control profiles for the cutter transport 90, the web handler transport 80, and the rotary motor 22 of cutter 21. This graph shows time on the x-axis and velocity on the y-axis. Cutter transport profile 61 has a triangular shape indicating constant acceleration and deceleration for its controlled motion. In steady state operation web handler profile 62 is preferably a straight line, indicating constant velocity feeding a loop 180 that is expanded and contracted while the cutter transport 90 undergoes the accelerations of profile 61. Blade profile 63 represents the rotary motion of the motor 22 for driving the blade 21. As seen in this preferred embodiment, the blade profile 63 is triangular, indicating constant acceleration during the downward stroke to BDC, and decelerating a constant rate while returning back to TDC.

To facilitate description of the proposed control method, this description assumes a guillotine cutter system 1 that executes an ‘Advance then Cut’ sequence triggered by a feed request 64. A feed request 64 is a command from the system controller to provide a next sheet for cutting and processing. Feed requests 64 will typically be received by the system periodically, but there may be pauses between feed requests 64 as downstream conditions indicate that the devices there are not ready to receive more sheets. One of skill in the art will understand that the control method described herein is adaptable for a ‘Cut then Advance’ sequence triggered by a Feed Request 64.

The present invention provides for precise displacement-based motion for cutter transport 90, blade motor 22 and web-handler transport 80 axes for a guillotine cutter system 1. For steady state operation, i.e. where a feed request 64 is always present, both the cutter transport 90 and blade motors follow triangular velocity profiles and the web-handler 80 motor follows a constant velocity profile.

If practical velocity limitations emerge for the cutter transport profile 61 or blade motion profile 63 (i.e. paper handling, scanning or motor/drive constraints), other profile types such as trapezoidal profiles can be substituted, however use of the triangular waveform minimizes accelerations for a given cut rate performance. Also, nominal web-handler motions 62 could be made more complex than constant velocity, i.e. periodic trapezoidal or sinusoidal profiles could be used. These more complex profiles may provide some incremental improvement for web control. However, constant velocity motion will significantly reduce the accelerations and forces as seen by the web and is the most straightforward motion to implement when the complexities of stopping and starting conditions are taken into consideration.

In the preferred embodiment, the driving parameter that determines the cut generation rate of the system is Cycle Time as illustrated in FIG. 6. Cycle Time is defined as the time between an actual feed request 64 and the earliest possible time that the next feed request 64 can be acted upon. If a new feed request 64 arrives before the end of the current Cycle Time, the feed request 64 is acted upon at the end of the current cycle. The Cycle Time value can be effectively changed to any value greater than or equal to a predetermined minimum allowable cycle time.

By way of example, motors and coupling ratios preferably accommodate a 36K cut/hr performance goal (72 K sheets/hr in 2-up mode) while generating 11 inch cut sheets. 36 K cut/hr equates to a minimum allowable cycle time of 100 ms. The commanded speed ratio parameter, k, is defined as the minimum allowable cycle time divided by the desired commanded cycle time where 0<=k<=1. Therefore, for 11 inch cut sheets when consecutive feed requests 64 are generated periodically every 100 ms, the corresponding speed ratio is 100%. The system rate is effectively controlled by changing the value of the speed ratio parameter. Since this parameter drives the Cycle Time, it can be changed to any value between 0 and 1 (100%) per cycle but also only takes effect at cycle boundaries.

Maximum accelerations and decelerations for the cutter transport 90, blade 21 and web-handler transport 80 axes are pre-determined based on the 36 K, 11 inch sheet condition in conjunction with predetermined motion overlap displacements between cutter transport 90 and blade 21 resulting from geometrical constraints and actual servo motion tolerances (includes accuracy and settle time). These same maximum acceleration and decelerations are used when cutting longer and shorter sheets, thereby resulting in lower and higher maximum cut sheet generation rates, respectively.

Motion profiles, as depicted in FIG. 6, for the cutter transport 90, blade 21 and web-handler transport 80 are displacement moves and all are determined at the feed request 64 and are executed using forward integration methods. For the preferred, ‘Advance then Cut’ implementation described herein, the cutter transport 90 motor begins its motion at the feed request 64.

As seen in FIG. 6, the cutter transport profile 61 is a triangular velocity motion profile executing a displacement move that begins at the feed request 64. It is computed based on the document length, speed rate, maximum cutter transport 90 acceleration and deceleration according to the following equations:

(In the following equations the term “tractor” refers to the preferred embodiment of cutter transport 90.)

Atractor=Tractor acceleration=k²(Atractor_max)
Dtractor=Tractor deceleration=k²(Dtractor_max), where Dtractor_max is always a negative value

$$\begin{matrix}Xtractor\_accel = Tractor accel displacement \\ = \frac{Ldoc}{( \frac{Atractor\_max}{- Dtractor\_max} + 1 )}\end{matrix}$$
Xtractor_decel=Tractor decel displacement=(Ldoc−Xtractor_accel)
   where:
Ldoc=the document length
k=the speed ratio
Atractor_max=the maximum tractor acceleration (predetermined)
Dtractor_max=the maximum tractor deceleration (predetermined)

As previously mentioned, if practical considerations warrant, this cutter transport profile 61 could also be a trapezoidal profile. For this case, an additional variable must be added to the above equations to limit the maximum velocity.

The blade profile 63 is a triangular velocity motion profile executing a 360-degree displacement move that begins when the cutter transport 90 has reached a pre-calculated displacement. The blade profile 63 is computed based on the speed rate, maximum blade acceleration and maximum blade deceleration according to the following equations:
Ablade=Blade acceleration=k²(Ablade_max)
Dblade=Blade deceleration=k²(Dblade_max), where Dblade_max is always a negative value

$$\begin{matrix}Xblade\_accel = Blade accel displacement \\ = \frac{360}{( \frac{Ablade\_max}{- Dblade\_max} + 1 )}\end{matrix}$$
Xblade_decel=Blade decel displacement=(360−Xblade_accel)
   where:
Ablade_max=the maximum tractor acceleration (predetermined)
Dblade_max=the maximum tractor deceleration (predetermined)

The blade 21 begins its motion profile 63 when the displacement of the cutter transport 90 is such that after the blade 21 has reached displacement, A (see FIGS. 5&6), the cutter transport 90 will have come to rest. Blade displacement, A, is the blade position from TDC where the blade just contacts the inner sheet of web 120 minus some amount for margin (includes servo settle time). The value of this cutter transport 90 displacement to begin the blade profile 63 is called Position Sense and is defined by:

$$Position Sense = Ldoc - A ( \frac{Dtractor\_max}{Dblade\_max} )$$

The web handler profile 62 is computed based on a positional move relative to the desired position of the web-handler transport 80 at the most previous cycle boundary. The final position is the desired position of the web-handler transport 80 at the most previous cycle boundary plus the cut sheet length. The initial velocity of the displacement move is the current desired velocity and the final velocity is the nominal desired web velocity, Vweb_nom.

An intercept algorithm is used to calculate the necessary motion profile 62 to accomplish this displacement in a time equal to the current value of Cycle Time using the initial and final desired velocities. Details of one possible algorithm are described in more detail below.

If a feed request 64 is not present at the end of a Cycle Time (i.e. a cycle boundary), the web-handler 80 will begin an immediate deceleration equal to Dweb. If the time from the cycle boundary to the next feed request 64 is sufficiently long, the web-handler 80 will come to rest. Velocities and accelerations for the web-handler 80 are defined as follows:
Vweb_nom=Web-handler velocity=k(Vweb_nom_max)
Aweb=Web-handler acceleration=k²(Aweb_max)
Dweb=Web-handler deceleration=k²(Dweb_max), where Dweb_max is always a negative value
   where:
Vweb_nom_max=(Ldoc)/(minimum allowable cycle time).
Aweb_max=the maximum web-handler acceleration (predetermined)
Dweb_max=the maximum web-handler deceleration (predetermined)

When the web-handler 80 does decelerate to rest, the resulting deceleration displacement is equal to Xloopstop. Xloopstop is the additional displacement added to the control loop 180 between the web-handler 80 and cutter transport 90 during a stopping condition and is computed as follows:

$$Xloopstop = \frac{{( Vweb\_nom )}^{2}}{( - 2 ( Dweb ) )}$$

Since the velocities and accelerations are appropriately scaled, when the web-handler 80 does go to rest due to the absence of a feed request 64, the value of Xloopstop is a constant regardless of the value of the speed ratio, k, for any given cycle.

By virtue of the displacement move being referenced to the desired position of the web-handler 80 at the last cycle boundary, the web-handler 80 will resynchronize itself at every cycle boundary, even if a feed request 64 is received during or after a deceleration to rest.

The system also includes a routine for initial paper loading and startup. The blade mechanism 21 is homed such that its crankshaft 25 resides at TDC of the stroke. During the web loading all motors are deactivated for operator safety. The web 120 is installed into the cutter transport 90 with the lead edge of the web 120 upstream of the sensors 12 and 13. Then the web 120 is installed into the web-handler 80 tractors and the web 120 is pulled tight by manually moving the web-handler 80 tractors without deforming the holes in the paper. The cover is closed and all three devices 22, 80, and 90 are activated to servo in place. Next the blade 21 mechanism is homed to TDC (top dead center). Next both cutter transport 90 and web-handler 80 motors execute a displacement move together to bring the lead edge to the cut location.

Next the web-handler 80 executes a displacement move equal to (Xloopnom+Xloopextra). Xloopnom is a calculated loop 180 displacement required at the start of the cutter transport profile 61 to ensure that the loop 180 size always remains a positive value during steady state operation. This displacement is calculated based on the smallest loop size condition, which occurs at the instant that the cutter transport velocity profile 61 falls below the web-handler velocity profile 62 during cutter transport 90 deceleration and is calculated as follows:
Xloopnom=Xtractor_{—}accel+Xdecel−Xweb
where:
Xtractor_accel=the displacement of the tractors during the entire acceleration.
Xdecel=the displacement of the tractors from the beginning of the deceleration to the point at which the velocity of the tractors equals the velocity of the web-handler.
Xweb=the displacement of the web during Xaccel and Xdecel.
where:

$$Xdecel = \frac{2 ( Atractor ) ( Xtractor\_accel ) - {( Vweb\_nom )}^{2}}{( - 2 ( Dtractor ) )}$$

$$\begin{matrix}Xweb = Vweb\_nom [ \sqrt{\frac{( 2 ) ( Xtractor\_accel )}{Atractor}} \pm \\ \frac{( \sqrt{2 ( Atractor ) ( Xtractor\_accel )} - Vweb\_nom )}{- Dtractor} ]\end{matrix}$$

Xloopextra is a design parameter that adds margin on the initial loop 180 size to ensure that the loop 180 size never gets close to zero during operation or to generally increase loop 180 size if a reliability benefit is realized from such. For example, this value can be about ½ inch. Therefore the actual initial loop 180 size before starting a cutter transport profile 61 is (Xloopnom+Xloopextra). Once this (Xloopnom+Xloopextra) displacement move is completed, the loading sequence is complete and the cutter 21 is now ready to execute full speed operation or operation at any speed ratio, k, upon receipt of a feed request 64. Recalling from previous discussion, in the absence of a feed request 64, the loop 180 size will increase further by displacement, Xloopstop.

The resulting total loop 180 size during a stopping condition is therefore:
Xlooptotal=(Xloopstop+Xloopnom+Xloopextra)

The following are exemplary parameters for the above equations for a preferred embodiment of the system for performing 36,000 cuts per hour:

For job parameter:

Ldoc=11.0 inches
   Design parameters:
Atractor_max=6383 in/s²=+16.5 G's
Dtractor_max=−6383 in/s²=−16.5 G's
Aweb_max=2200 in/s2=+5.7 G's
Dweb_max=−2200 in/s²=−5.7 G's
Ablade_max=1,000,000 degrees/s²
Dblade_max=−1,000,000 degrees/s²
A=55 degrees (the position from TDC where the blade just contacts the inner sheet, minus a little for margin)
C=305 degrees (the position from TDC where the blade just clears the inner sheet, plus a little for margin, Normally C=360−A)
Xloopextra=0.50 inches
   Results in the following values:
Tractor Time=0.083 s
Blade Time=0.038 s
Tractor Dwell Time=0.017 s
Total Cycle Time=0.100 s (36 Kcuts/hr)
Xloopstop=2.750 inches
Xloopnom=2.815 inches
Xlooptotal=6.065 inches (total loop size during a stoppage)

As described above in connection with web handler profile 62, an intercept algorithm is used to define the velocity of the web handler transport 80 as a function of time from an initial velocity to a final velocity over a fixed time period with the axis experiencing a fixed displacement. The following is a preferred embodiment of the intercept algorithm, although it will be understood by one of ordinary skill in the art that other intercept algorithms may be used. Given:

vi=initial velocity

vf=final velocity

tx=time for the profile to execute

dx=displacement incurred during the profile

The intercept algorithm determines an acceleration that may be applied from vi to an intermediate vm and then reversed (multiplied by −1.0), and applied from vm to the given vf The intercept algorithm calculates the values for a (the acceleration) and vm without bound.

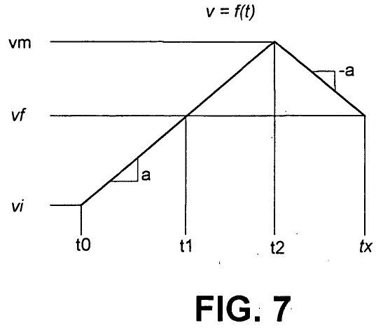

FIG. 7 an exemplary solution of the preferred intercept algorithm for the web handler profile 62 where the initial velocity vi is less then the desired final velocity vf. It will be understood that such a situation would arise when web handler transport 80 has decelerated as a result of the previous cycle ending without a feed request 64 being immediately present.

t1=time at which the changing velocity reaches vf the 1^{st} time

t2 time to accelerate from vi to vm

Let d1 be the displacement from t0 to t2.

Let d2 be the displacement from t2 to tx

Therefore:
dx=d1+d2
The expressions d1 and d2 may be expressed in terms of vm,vi,vf, and a.

$$d 1 = \frac{{vm}^{2} - {vi}^{2}}{2 a}$$

$$d 2 = - \frac{{vf}^{2} - {vm}^{2}}{2 a}$$

So dx in terms of vm,vi,vf and a results in the equation:

$$dx = \frac{{vm}^{2} - {vi}^{2}}{2 a} - \frac{{vf}^{2} - {vm}^{2}}{2 a}$$

Solving for vm:

$$\frac{1}{2} \sqrt{4 dxa + 2 {vi}^{2} + 2 {vf}^{2}} , - \frac{1}{2} \sqrt{4 dxa + 2 {vi}^{2} + 2 {vf}^{2}}$$

Solve for a . . . call this equation 1

$$\frac{2 {vm}^{2} - {vi}^{2} - {vf}^{2}}{2 dx}$$

Referring to the velocity graph of FIG. 7, since the acceleration from vi to vm has the inverse slope (decel=accel*−1.0) of the acceleration from vm to vf, then t2−t1 must equal tx−t2, or

$$t 2 = \frac{1}{2} tx + \frac{1}{2} t 1$$

The similar triangles gives us

$$\frac{t 1}{vf - vi} = \frac{t 2}{vm - vi}$$

Substituting t2 from the previous equation results in:

$$\frac{t 1}{vf - vi} = \frac{tx + t 1}{2 vm - 2 vi}$$

And solve for t1

$$- \frac{tx ( vf - vi )}{- 2 vm + vi + vf}$$

Now using the equation:
vf=vi+αt1
and substitute what we concluded about t1 previously:

$$vf = vi - \frac{a tx ( vf - vi )}{- 2 vm + vi + vf}$$

and solve for α . . . call this equation 2

$$- \frac{- 2 vm + vi + vf}{tx}$$

Using, equation 1 and equation 2 here are both expressions for the acceleration derived
from different approaches . . . and they must be equal

$$\frac{2 vm - vi - vf}{tx} = \frac{2 {vm}^{2} - {vi}^{2} - {vf}^{2}}{2 dx}$$

So now we have an equation with one unknown . . . vm
Solving for vm:

$$\frac{4 dx + 2 \sqrt{4 {dx}^{2} + 2 {tx}^{2} {vi}^{2} - 4 tx dx vi - 4 tx dx vf + 2 {tx}^{2} {vf}^{2}}}{4 tx} , \\ \frac{4 dx - 2 \sqrt{4 {dx}^{2} + 2 {tx}^{2} {vi}^{2} - 4 tx dx vi - 4 tx dx vf + 2 {tx}^{2} {vf}^{2}}}{4 tx}$$

Once vm is determined, use equation 2 to solve for a
Test the results produced by both roots (plus or minus 2 times the radical) . . . one will be correct.

The following is exemplary embodiment of the intercept algorithm in computer code:

// InterceptProfile . . . accels from vi to vf in a given time and creating a
given displacement
//
// vi = initial velocity vf = final velocity tx = the profile must
reach vf from inception in tx seconds
// dx = the displacement experienced during the profile must be dx.
//
// returns:
// true/false for success/failure
// *pa = acceleration
// *pm = velocity
//
// The path accels/decels from vi to *pm and then decels/accels
( . . . −1.0 * (*pa)) to vf. The time will be tx.
//
BOOL CInterceptProfileDlg::InterceptProfile(double vi, double vf,
double tx, double dx, double *pa, double *pv)
{

BOOL bret = FALSE;
if ((NULL ! = pa) && (NULL ! = pv) && (0.0 < tx))
{

double y = 4*dx*dx + 2*tx*tx* (vi*vi + vf*vf) − 4*tx*dx*
(vf + vi); if (0.0 <= y)
{

bret = TRUE;
double x = 2 * sqrt (y);
double vp = (4*dx + x) / (4*tx);
double ap = (2*vp−vi−vf) / tx;
double vn = (4*dx − x) / (4*tx);
double an = (2*vn−vi−vf) / tx;
double tpos = (0.0 != ap)? ((vp−vi) / ap) : 0.0;
double tneg = (0.0 != an)? ((vn−vi) / an) : 0.0;
int f = ((0.0 < tpos) && (tx >= tpos) && (0.0 != ap))?

1 : 0; // if the pos root is possible f =1

f |= ((0.0 < tneg) && (tx >= tneg) && (0.0 != an))?

2 : 0; // if the neg root is possible f |=2
if both possible f = 3 //

switch (f)
{
case 1: *pv = vp;// Positive Root (only)
*pa = ap;
break;
case 2: *pV = vn;// Negative Root (only)
*pa = an;
break;
case3:

{

// both possible . . . one correct
double dn = ((vn*vn) − (vi*vi)) / (2*an) +

((vf*vf) − (vn*vn)) / (−2.0*an)

double dp = ((vp*vp) − (vi*vi)) / (2*ap) +

((vf*vf) − (vp*vp)) / (−2.0*ap)

if (fabs (dx−dn) < fabs (dx−dp))
{

*pv = vn; // Negative Root (best)
*pa = an;

}
else
{

*pv = vp; // Positive Root (best)
*pa = ap;

{

{
break;

default:

if ((vi == vf) && (dx == (vi*tx)))
{

*pv = vi; // No Accel
*pa = 0.0;

}

else bret = FALSE; // can't solve (?)

break;

}

}

}
return bret;

}

Throughout this application the preferred web moving mechanisms have been described as tractors. However, it is also possible to use wheels and rollers to move the web. This is known in the industry as pinless tractors. With wheels and rollers, it is not necessary to provide sprocket holes of the web.

Although the invention has been described with respect to a preferred embodiment thereof, it will be understood by those skilled in the art that the foregoing and various other changes, omissions and deviations in the form and detail thereof may be made without departing from the scope of this invention.

What is claimed is:

1. A high speed input system for separating individual sheets from a continuous web for creating mail pieces in an inserter machine, the input system comprising:
a guillotine cutter blade arranged to cyclically transversely cut the web transported past the cutter blade;
a cutter transport arranged to cyclically feed and stop the web in a path adjacent to the cutter blade for cutting by the cutter blade;
a web handler transport upstream of the cutter transport and providing web to the cutter transport at lower peak velocities and accelerations than are experienced by the web at the cutter transport, the web handler transport including a loop forming arrangement;
a controller programmed to control operation of the high speed input system in a synchronized manner in order to maximize throughput, the controller programmed to control the high speed input system in accordance with a repeating cycle, wherein each repeating cycle has a cycle time, the cycle time being determined as an amount of time between a first web feed request and an earliest possible time that a subsequent second web feed request can be acted upon, and wherein during each cycle the controller controls the system in accordance with:
a cutter transport motion control profile whereby the cutter transport initiates feeding of a document length of web after receiving the first feed request, the cutter transport stopping when the document length of web has been fed;
a cutter motion control profile whereby the cutter blade begins moving in a cutting direction when the cutter transport has moved the web a trigger distance that is less than the document length, and whereby the trigger distance is such that the cutter blade will first make contact with the web immediately when the web has been halted by the cutter transport motion profile, whereby the cutter blade is returned to its initial position after having completed its cutting of the web, and whereby the cutter transport motion control profile begins moving the web for the second feed request, for a subsequent cycle, as soon as the cutter blade clears the web, and not waiting until the cutter blade is at a resting position;
a web handler transport motion control profile whereby during each cycle the web handler moves the web the document length at peak velocities and accelerations less than the peak velocities and accelerations of the cutter transport, and whereby at the end of the cycle the web is transported at a nominal velocity selected to maintain the loop in the web handler, whereby the loop expands and contracts as the downstream cutter transport stops and starts as the cutter blade cuts the web in each cycle.

2. The high speed input system of claim 1 wherein the cutter transport motion control profile is comprised of a constant acceleration for half of the document length and a constant deceleration for the other half of the document length.

3. The high speed input system of claim 1 wherein the cutter blade is coupled by a cutter arm to a rotary motor and whereby one full rotation of the rotary motor corresponds to one complete cutting sequence of the cutter blade and wherein the cutter blade motion control profile is comprised of a constant acceleration for a first half of the rotation while the cutter blade is moving in the cutting direction and a constant deceleration for a second half of the rotation while the cutter blade is returning to its initial position.

4. The high speed input system of claim 1 wherein the web handler transport motion control profile comprises steady motion at the nominal velocity in steady state when a new feed request is present at the end of each cycle.

5. The high speed input system of claim 4 wherein if no feed request is present at the end of the cycle, the web handler transport motion control profile decelerates the web at a constant deceleration until the web comes to a stop, or until a subsequent feed request is received.

6. The high speed input system of claim 5 wherein the web handler transport motion control profile includes an intercept algorithm that is employed at the beginning of each cycle and whereby the web handler transport motion control profile is determined to accomplish a displacement of the document length within the cycle time starting at a current velocity and ending at the nominal velocity.

7. The high speed input system of claim 6 wherein the intercept algorithm calculates the web handler transport motion control profile as a constant acceleration and a constant deceleration during the cycle.

8. The high speed input system of claim 1 wherein the controller further includes a start-up profile for handling the web as it is first installed into the high speed input system, the start-up profile controlling the cutter transport and the web handler transport to bring a lead edge of the web to a first cut location, and wherein the web handler further executes a nominal loop displacement, the nominal loop displacement being a function of a differential displacement between the cutter transport and the web handler transport during steady state operation.

9. The high speed input system of claim 1 arranged for handling of a web having a 2-up sheet configuration having sheets side-by-side on the web, the system further comprising a center cutting device positioned upstream of the guillotine cutter, the center cutting device splitting the side-by-side portions of the web.

10. A method for controlling a high speed input system for separating individual sheets from a continuous web for creating mail pieces in an inserter machine, the input system comprising:
a guillotine cutter blade arranged to cyclically transversely cut the web transported past the cutter blade;
a cutter transport arranged to cyclically feed and stop the web in a path adjacent to the cutter blade for cutting by the cutter blade;
a web handler transport upstream of the cutter transport and providing web to the cutter transport at lower peak velocities and accelerations than are experienced by the web at the cutter transport, the web handler transport including a loop forming arrangement;
the method comprising:
controlling operation of the high speed input system in a synchronized manner in order to maximize throughput, the controller programmed to control the high speed input system in accordance with a repeating cycle, wherein each repeating cycle has a cycle time, the cycle time being determined as an amount of time between a first web feed request and an earliest possible time that a subsequent second web feed request can be acted upon, and during each cycle controlling the system in accordance with:
a cutter transport motion control profile whereby the cutter transport initiates feeding of a document length of web after receiving the first feed request, the cutter transport stopping when the document length of web has been fed;
a cutter motion control profile whereby the cutter blade begins moving in a cutting direction when the cutter transport has moved the web a trigger distance that is less than the document length, and whereby the trigger distance is such that the cutter blade will first make contact with the web immediately when the web has been halted by the cutter transport motion profile, whereby the cutter blade is returned back to its initial position after having completed its cutting of the web, and whereby the cutter transport motion control profile begins moving the web for the second feed request, for a subsequent cycle, as soon as the cutter blade clears the web, and not waiting until the cutter blade is at a resting position;
a web handler transport motion control profile whereby during each cycle the web handler moves the web the document length at peak velocities and accelerations less than the peak velocities and accelerations of the cutter transport, and whereby at the end of the cycle the web is transported at a nominal velocity selected to maintain the loop in the web handler, whereby the loop expands and contracts as the downstream cutter transport stops and starts as the cutter blade cuts the web in each cycle.

11. The method of controlling the high speed input system of claim 10 wherein the step of controlling in accordance with the cutter transport motion control profile is comprised of a constant acceleration for half of the document length and a constant deceleration for the other half of the document length.

12. The method of controlling the high speed input system of claim 10 wherein the cutter blade is coupled by a cutter arm to a rotary motor and whereby one full rotation of the rotary motor corresponds to one complete cutting sequence of the cutter blade and wherein the step of controlling in accordance with the cutter blade motion control profile is comprised of a constant acceleration for a first half of the rotation while the cutter blade is moving in the cutting direction and a constant deceleration for a second half of the rotation while the cutter blade is returning to its initial position.

13. The method of controlling the high speed input system of claim 10 wherein the step of controlling in accordance with the web handler transport motion control profile comprises steady motion at the nominal velocity in steady state when a new feed request is present at the end of each cycle.

14. The method of controlling the high speed input system of claim 13 wherein if no feed request is present at the end of the cycle, the step of controlling in accordance with the web handler transport motion control profile decelerates the web at a constant deceleration until the web comes to a stop, or until a subsequent feed request is received.

15. The method of controlling the high speed input system of claim 14 wherein step of controlling in accordance with the web handler transport motion control profile includes an intercept algorithm that is employed at the beginning of each cycle and whereby the web handler transport motion control profile is determined to accomplish a displacement of the document length within the cycle time starting at a current velocity and ending at the nominal velocity.

16. The method of controlling the high speed input system of claim 15 wherein the intercept algorithm calculates the web handler transport motion control profile as a constant acceleration and a constant deceleration during the cycle.

17. The method of controlling the high speed input system of claim 10 wherein the step of controlling further includes a start-up profile handling the web as it is first installed into the high speed input system, the start-up profile controlling the cutter transport and the web handler transport to bring a lead edge of the web to a first cut location, and wherein the web handler further executes a nominal loop displacement, the nominal loop displacement being a function of a differential displacement between the cutter transport and the web handler transport during steady state operation.

18. The method of controlling the high speed input system of claim 1 arranged for handling of a web having a 2-up sheet configuration having sheets side-by-side on the web, the method further comprising splitting the side-by-side portion of the web upstream of the guillotine cutter.
